(19) United States
(12) Patent Application Publication
(10) Pub. No.: US 2022/0385481 A1
(43) Pub. Date: Dec. 1, 2022

(54) CERTIFICATE-BASED MULTI-FACTOR AUTHENTICATION

(71) Applicant: International Business Machines Corporation, Armonk, NY (US)

(72) Inventors: Jonathan William Edwards, Fayette, KY (US); David Howard Evans, Lexington, KY (US); David Wayne Glass, Georgetown, KY (US); Richard Victor Kisley, Charlotte, NC (US); Luna Benarroch Mulat, Bronx, NY (US)

(21) Appl. No.: 17/335,118

(22) Filed: Jun. 1, 2021

(51) Int. Cl. H04L 9/32; H04L 9/08

(52) U.S. Cl. CPC H04L 9/3263; H04L 9/3247; H04L 9/0825; H04L 9/0877

(57) ABSTRACT

Embodiments of the invention provide a computer-implemented method of executing multi-factor authentication (MFA). In embodiments of the invention, the computer-implemented method includes analyzing multiple categories of MFA factors, wherein a first category of the multiple categories of MFA factors includes a something-you-have MFA (SYH-MFA) factor. The SYH-MFA factor is analyzed by receiving, using a processor of an authenticating entity, an SYH certificate from a to-be-authenticated (TBA) entity; and determining, using the processor, that the SYH-MFA factor is satisfied by determining that the SYH certificate possessed by the TBA entity is valid.

### BACKGROUND

The present invention relates generally to programmable computer systems. More specifically, the present invention relates to computer systems, computer-implemented methods, and computer program products that implement novel certificate-based multi-factor authentication techniques that can be used by a variety of computing systems, including, for example, embedded computing systems.

Coprocessors are supplementary processors that take over the responsibility for performing selected processor-intensive tasks of an associated central processing unit (CPU) in order to allow the CPU to focus its computing resources on tasks that are essential to the overall system. A coprocessor's tasks can include input/output (I/O) interfacing, encryption, string processing, floating-point arithmetic, signal processing, and the like. Coprocessors can include one or more embedded systems (ES). An ES is a computer system that performs one or more dedicated functions within a larger mechanical and/or electronic system. An example of an ES is a bootstrap loader (or boot loader), which serves as a mediator between the computer's hardware and the operating system. In some computer configurations, the coprocessor itself can be considered an embedded system.

Authentication is any process used by an information system to verify the identity of a user, process, or device as a prerequisite to allowing the user, process, or device to access resources in the information system. Authentication processes involve the analysis of factors that typically fall within one of three categories (or types)—something you know (e.g., passwords); something you have (e.g., a wireless keycard); and/or something you are (e.g., a scanned fingerprint). Multi-factor authentication (MFA) provides greater security against unauthorized access by requiring an entity to satisfy two different authentication requirements/factors (e.g., a password and a fingerprint scan).

### SUMMARY

Embodiments of the invention provide a computer-implemented method of executing multi-factor authentication (MFA). In embodiments of the invention, the computer-implemented method includes analyzing multiple categories of MFA factors, wherein a first category of the multiple categories of MFA factors includes a something-you-have MFA (SYH-MFA) factor. Analyzing the SYH-MFA factor includes receiving, using a processor of an authenticating entity, an SYH certificate from a to-be-authenticated (TBA) entity; and determining, using the processor, that the SYH-MFA factor is satisfied by determining that the SYH certificate possessed by the TBA entity is valid.

Embodiments of the invention also provide computer systems and computer program products for having substantially the same features as the computer-implemented method described above.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a system embodying aspects of the invention;

FIG. 2 depicts a flow diagram illustrating a method embodying aspects of the invention;

FIG. 3 depicts a system embodying aspects of the invention;

FIG. 4 depicts a system embodying aspects of the invention;

FIG. 5 depicts a system embodying aspects of the invention; and

FIG. 6 depicts details of an exemplary computing system capable of implementing aspects of the invention.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the function units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components, modules, sub-function, and the like of the systems illustrated herein are depicted separately for ease of illustration and explanation. In embodiments of the invention, the operations performed by the various components, modules, sub-functions, and the like can be distributed differently than shown without departing from the scope of the various embodiments of the invention describe herein unless it is specifically stated otherwise.

For convenience, some of the technical operations described herein are conveyed using informal expressions. For example, a processor that has key data stored in its cache memory can be described as the processor “knowing” the key data. Similarly, a user sending a load-data command to a processor can be described as the user “telling” the processor to load data. It is understood that any such informal expressions in this detailed description should be read to cover, and a person skilled in the relevant art would understand such informal expressions to cover, the informal expression's corresponding more formal and technical description.

Turning now to an overview of aspects of the invention, embodiments of the invention provide computer systems, computer-implemented methods, and computer program products that implement novel certificate-based multi-factor authentication (MFA) techniques that can be used by a variety of computing systems, including, for example, embedded computing systems, coprocessors, hardware security modules, and the like. In general, digital certificates or public key certificates are digital documents that securely associate cryptographic key pairs (i.e., a public key paired with a private key) with identities such as websites, individuals, or organizations. The novel MFA techniques described herein are certificate-based in that they use multiple digital certificates in unique ways as the basis for satisfying multiple distinct authentication factors of an MFA protocol. More specifically, as previously noted herein, MFA methods require the validation of multiple distinct authentication factors in one of three major categories (or types)—something you know (e.g., passwords); something you have (e.g., a wireless keycard); and/or something you are (e.g., a scanned fingerprint). Embodiments of the invention utilize a novel “something-you-have” (SYH) digital certificate generated and authenticated in a manner that allows it to perform a new role for digital certificates, which is to satisfy an SYH authentication factor. In some embodiments of the invention, the SYH digital certificate can be authenticated by using the system performing the authentication to evaluate key data of the SYH digital certificate to determine that the SYH digital certificate belongs to the entity that wishes to be authenticated. In some embodiments of the invention, the key data is a public key of the SYH certificate. The system performing the authentication trusts that the public key belongs to the entity that wishes to authenticate because the system performing the authentication has a SYK digital certificate for the public key, which includes the entity's identity, its public key, and a digital signature generated by a trusted “certificate authority” whose public key is generally known. Accordingly, in the novel MFA protocol, the SYH digital certificate functions as a token because it is something that the entity that wishes to authenticate can present (without signing it) as something the entity has. The presented token is validated not for the purpose of confirming that the entity presenting the token knows something (i.e., a private key) but to confirm that the entity presenting the token has something (i.e., a valid SYH digital certificate/token).

In some embodiments of the invention, the novel SYH digital certificate is used with a second MFA factor to implement the novel certificate-based MFA protocol. In some embodiments of the invention, the second MFA factor is a “something you know” (SYK) digital certificate generated and authenticated in a manner that allows it to perform the traditional role of digital certificates, which is to satisfy an SYK authentication factor. In some embodiments of the invention, the SYK digital certificate is authenticated by evaluating a digital signature of the SYK digital certificate. The system performing the MFA protocol has a public key, and the entity that wishes to authenticate proves to the system that it knows the corresponding private key by using the corresponding private key to generate the SYK digital signature, which the system performing the authentication can verify. In some embodiments of the invention, because the public key of the entity that wishes to be authenticated is already known to the authenticator, the SYK digital certificate presented by the entity that wishes to authenticate does not need to include the value of that entity's public key, which is not in keeping with the known ways in which SYK digital certificates are used.

In some embodiments of the invention, the signing processes described herein can be hybrid quantum safe (Q-S), which means that the signing processes utilize cryptographic algorithms that resist attacks from classical computers as well as from quantum computers. Accordingly, the signing schemes utilized herein can be conventional (e.g., ECC), hybrid Q-S (e.g., ECC plus Dilithum), and/or Q-S (e.g., Dilithum). Dilithium is a lattice-based cryptographic scheme configured to preserve the robustness of its security model in the presence of quantum computers. ECC is a cryptographic scheme that uses the mathematical properties of elliptic curves to produce public key cryptographic systems.

In some aspects of the invention, the authenticating entity includes computing resources, and the entity that wishes to authenticate is seeking authentication so it can make changes to the computing resources by issuing commands to the computing resources. A command can be an instruction to a computer to do something, such a run a single program, a portion of the program, or a group of linked programs. A command can also be an instruction to the computer to load a single program, a portion of a program, or a group of linked programs. A command can also be an instruction to make other changes to state (e.g., loading keys). In some aspects of the invention, the novel MFA protocol requires the validation of authentication factors for each command or grouping of commands submitted to the authenticating entity.

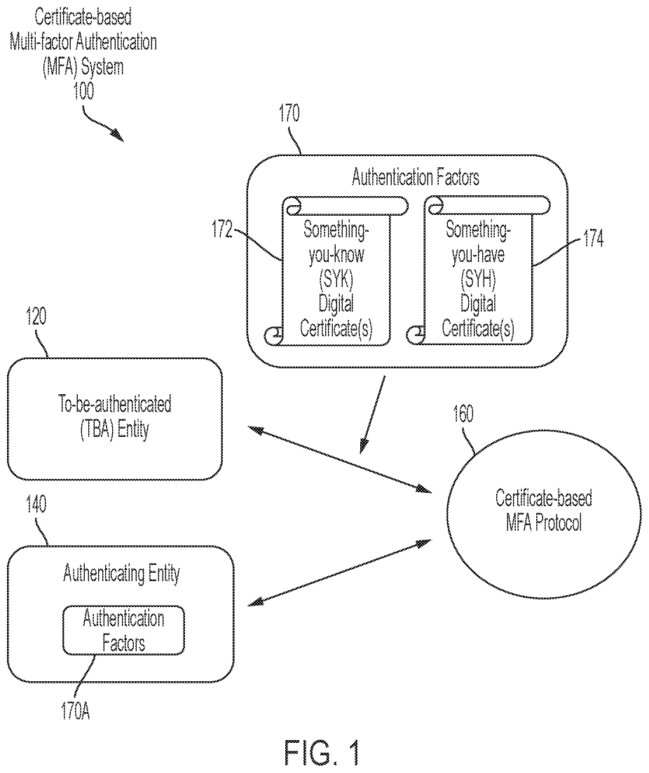

Turning now to a more detailed description of aspects of the invention, FIG. 1 depicts a certificate-based MFA system 100 in accordance with embodiments of the invention. As shown, the system 100 includes an authenticating entity 140, a to-be-authenticated (TBA) entity 120, and a certificate-based MFA protocol 160, configured and arranged as shown. In embodiments of the invention, the authenticating entity 140 can be any computing systems for which it is desirable or necessary to control access to the computer system's resources. The authenticating entity 140, in some embodiments of the invention, can be an embedded system, a coprocessor, a hardware security module, and the like. The certificate-based MFA protocol 160 is depicted separately for ease of illustration and explanation. In some embodiments of the invention, the operations performed by the certificate-based MFA protocol 160 can be distributed differently than shown without departing from the scope of the various embodiments of the invention describe herein unless it is specifically stated otherwise. For example, in some embodiments of the invention, some or all of the operations of the certificate-based MFA protocol 160 can be incorporated within the authenticating entity 140 or another local or remote computing system (not shown). In embodiments of the invention, the certificate-based MFA protocol 160 controls the authenticating entity 140 to execute the novel certificate-based MFA protocol 160, wherein a novel SYH digital certificate 174 is used as an SYH authentication factor.

Referring still to FIG. 1, one or more offline certificate authority systems (not shown in FIG. 1) in secure locations are used to securely generate authentication factors 170, which include SYK digital certificate(s) 172 and SYH digital certificate(s) 174 in accordance with embodiments of the invention. As an entity that generates digital signatures, the certificate authority system is maintained offline for security reasons. The certificate authority system being offline means that the operations used to generate the authentication factors 170 do not involve the transmission of information over publicly accessible networks. In accordance with embodiments of the invention, the authentication factors 170 verify credentials of authorized entities that possess various rights with respect to the resources of the authenticating entity 140. In some aspects of the invention, the authorized entities can be the owners of resources of the authenticating entity 140, and the rights of the authorized entities can include having the authority to make changes to the resources of the authenticating entity 140. In some embodiments of the invention, the changes to the resources can take the form of commands. In some embodiments of the invention, the command can be an instruction for the authenticating entity 140 to do something, such a run a single program, a portion of the program, or a group of linked programs. In some embodiments of the invention, the command can be an instruction to the computer to load a single program, a portion of a program, or a group of linked programs. In some embodiments of the invention, the command can also be an instruction to make other changes to the state of the resources (e.g., loading keys). When the authentication factors 170 are completed by the offline certificate authority system(s), the authentication factors 170 are made available to the TBA entities 120. In general, the TBA entity 120 should be the previously-described authorized entity or its agent. However, the novel certificate-based MFA protocols 160 are provided to protect against situations in which the TBA entity 120 is an unauthorized entity that is attempting to access the resources of the authenticating entity 140. When the authentication factors 170 are completed, various parameters of the authentication factors 170A are loaded onto the authenticating entity 140 so the factors 170A can be used to perform factor validation operations of the authentication factors 170 during execution of the certificate-based MFA protocol 160.

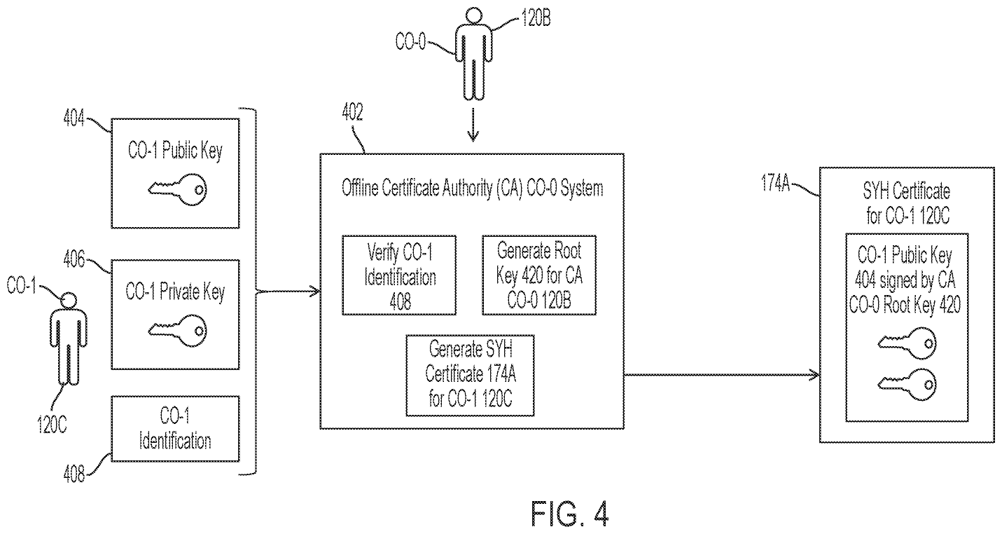

In accordance with embodiments of the invention, the certificate-based MFA protocol 160 controls the authenticating entity 140 to analyze multiple categories of MFA factors. A first one of the multiple categories of MFA factors includes the novel SYH digital certificate 174. In accordance with embodiments of the invention, the SYH certificate 174 is configured such that the TBA entity 120 can satisfy the SYH authentication factor by presenting an SYH certificate 174, unaltered by the TBA entity 120, to the authenticating entity 140 and having the authenticating entity 140 determine that the SYH certificate 174 presented by the TBA entity 120 is valid. In some embodiments of the invention, the SYH certificate 174 is unaltered by the TBA entity 120 in that the TBA entity 120 does not sign the SYH certificate 174. In some embodiments of the invention, the SYH certificate 174 includes key data that the authenticating entity 140 can evaluate against the authentication factors 170A to determine that the key data of the SYH certificate in the possession of the TBA entity 120 is valid. In some embodiments of the invention, the key data of the SYH certificate 174 is a public key of the authorized entity. In some embodiments of the invention, the authenticating entity 140 determines that the public key of the SYH certificate 174 is the public key of the authorized entity by comparing the public key of the SYH certificate 174 to the public key of the authorized entity; and determining that the public key of the SYH certificate 174 has been digitally signed by the certificate authority system using a root key that is known to the authenticating entity 140 and associated with a certificate authority cryptographic officer (e.g., CA CO-0 120B shown in FIG. 4).

In some embodiments of the invention, a second one of the multiple categories of MFA factors is the SYK digital certificate 172. The SYK certificate 172 can be configured such that the TBA entity 120 satisfies the SYK authentication factor by presenting to the authenticating entity 140 the SYK digital certificate 172 from the TBA entity 120, wherein the SYK digital certificate 172 includes an SYK digital signature created by the TBA entity 120. The authenticating entity 140 determines that the second category of factors is satisfied by determining that the SYK digital signature 172 created by the TBA entity 120 is valid.

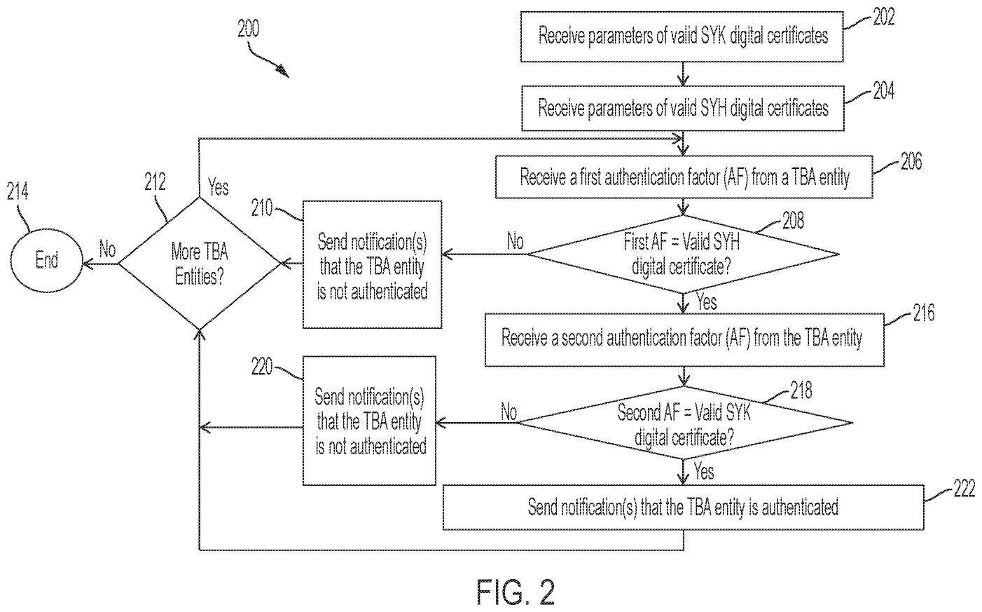

FIG. 2 depicts a computer-implemented method 200 in accordance with aspects of the invention. The method 200 is performed by the authenticating entity 140 (shown in FIG. 1) under the direction of the certificate-based MFA protocol 160 (shown in FIG. 1). In accordance with aspects of the invention, the method 200 executes an MFA method, wherein first and second authentication factors are evaluated to authenticate the TBA entity 120.

At blocks 202, 204 of the method 200, the authenticating entity 140 receives parameters of valid SYK certificates and valid SYH certificates (e.g., authentication factors 170A shown in FIG. 1). At block 206, the authenticating entity 140 receives a first authentication factor (AF) from the TBA entity 120, and, at decision block 208, the authenticating entity 140 determines whether the first AF is a valid SYH digital certificate 174. In some embodiments of the invention, the SYH digital certificate 174 is unsigned by the TBA entity 120, and any suitable method of validating the SYH digital certificate 174 can be used. In some embodiments of the invention, the authenticating entity 140 evaluates the validity of the SYH digital certificate 174 using the previously-described methodologies for how the authenticating entity 140 determines the validity of the SYH digital certificate 174. If the answer to the inquiry at decision block 208 is no, the method 200 moves to block 210 and sends notifications (e.g., back to the TBA entity 120) that the TBA entity 120 and/or any commands presented to the authenticating entity 140 are not authenticated. From block 210, the method 200 moves to decision block 212 to determine whether or not additional commands and/or TBA entities 120 being presented to the authenticating entity 140. If the answer to the inquiry at decision block 212 is no, the methodology 200 moves to block 214 and ends. If the answer to the inquiry at decision block 212 is yes, the method 200 returns to decision block 206 to evaluate a next set of first and second AFs.

Returning to decision block 208, if the answer to the inquiry at decision block 208 is yes, the method 200 move to block 216 where the authenticating entity 140 receives a second AF from the TBA entity 120. At decision block 218, the authenticating entity 140 determines whether the second AF is a valid SYK digital certificate 172. In some embodiments of the invention, any suitable method of validating the SYK digital certificate 172 can be used. In some embodiments of the invention, the authenticating entity 140 evaluates the validity of the SYK digital certificate 172 using the previously-described methodologies for how the authenticating entity 140 determines the validity of the SYK digital certificate 172. If the answer to the inquiry at decision block 218 is no, the method 200 moves to block 220 and sends notifications (e.g., back to the TBA entity 120) that the TBA entity 120 and/or any commands presented to the authenticating entity 140 are not authenticated. From block 220, the method 200 moves to decision block 212 to determine whether or not there are additional commands and/or TBA entities 120 presented to the authenticating entity 140. If the answer to the inquiry at decision block 212 is no, the methodology 200 moves to block 214 and ends. If the answer to the inquiry at decision block 212 is yes, the method 200 returns to decision block 206 to evaluate a next set of first and second AFs.

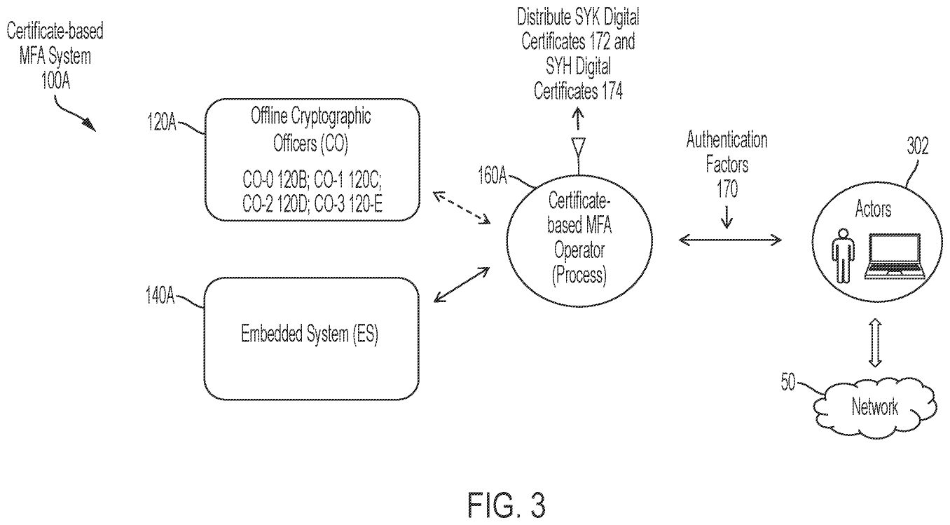

FIG. 3 depicts a certificate-based MFA system 100A in accordance with embodiments of the invention. System 100A leverages the functional principles of the system 100 (shown in FIG. 1), but the system 100A depicts an example of how the function principles shown in system 100 can be applied in a particular computing environment. As shown in FIG. 3, the system 100A includes an embedded system (ES) 140A, a set of cryptographic officers (CO) 120A, and a certificate-based MFA operator 160A, configured and arranged as shown. In embodiments of the invention, the ES 140A can be any computing system for which it is desirable or necessary to control access to its resources. As non-limiting examples, in some embodiments of the invention, the ES 140A can be implemented as a wide variety of computing system, including, for example, a coprocessor and/or a hardware security module.

In some embodiments of the invention, the COs 120A include a CO-1 120C, a CO-2 120D, and a CO-3 120E, which are entities (e.g., persons, systems, and/or organizations) that own some or all of the resources of the ES 140A, and which are the entities that will be authenticated by the ES 140A under the control and direction of the certificate-based operator 160A. More specifically, CO-1 120C can be configured to own all of the resources of the ES 140A and can be further configured to assign ownership of subsets of the resources of the ES 140A to CO-2 120D. Additionally, CO-2 120D can assign some of the resources it owns to CO-3 120E. In some embodiments of the invention, the SYK digital certificate 172 is generated by one or more of the CO-1 120C, the CO-2 120D, and the CO-3 120E. In some embodiments of the invention, the SYH digital certificate 174 (shown in FIG. 1) can be generated by including among the COs 120A a CO-0 120B, which is an entity (person, system, and/or organization) configured and arranged to function within the system 100A as a certificate authority (i.e., CA-CO-0 120B) that generates the SYH digital certificate 174.

The certificate-based MFA operator 160A is depicted separately for ease of illustration and explanation. In some embodiments of the invention, the operations performed by the certificate-based MFA operator 160A can be distributed differently than shown without departing from the scope of the various embodiments of the invention describe herein unless it is specifically stated otherwise. For example, in some embodiments of the invention, some or all of the operations of the certificate-based MFA operator 160A can be incorporated within the authenticating entity 140 or another local or remote computing system (not shown). In embodiments of the invention, the certificate-based MFA operator 160A controls the ES 140A to execute the novel certificate-based MFA operator 160A, wherein the novel SYH digital certificate 174 is used an SYH authentication factor. In some embodiments of the invention, the certificate-based MFA operator 160A is further configured to distribute or publish the SYK digital certificates 172 and the SYH digital certificates 174.

FIG. 3 further depicts actors 302. In the system 100A, the actors 302 represent humans, host-side device drivers, applications, and the like that take the distributed/published SYK/SYH digital certificates and transmit them through the certificate-based MFA operator 160A to the ES 160A in an overall command package. In known system configurations, the actors 302 would ordinarily be the person or thing the system would authentic. However, in the system 100A, the actors 302 are instead part of a process that transports the information to be authenticated (commands and certificates 172, 174) from the COs 120A to the ES 140A. Actors 302 are also connected to a network 50 for performing other tasks over network communications.

FIG. 4 depicts an offline CA CO-0 system 402 that can be used to generate SYH digital certificates such as SYH digital certificate 174 (shown in FIG. 1) and/or SYH digital certificate 174A in accordance with aspects of the invention. The CO-1 120C, operating on some type of client computer, has previously obtained or generated a public/private key pair, e.g., CO-1 public key 404 and CO-1 private key 406. The CO-1 120C also generates CO-1 identification 408, which is a variety of types of information that identifies CO-1. The CO-1 120C generates a request for certificate (not shown) containing CO-1 public key 404 and the CO-1 identification 408 and sends the request to the CA CO-0 system 402, which is in possession of a root key 420 for the CA CO-0 system 402. CA CO-0 system 402 verifies the identity of the CO-1 120C in some manner and generates the SYH digital certificate 174A containing CO-1 public key 404 that was signed with the CA CO-0 root key 420. The SYH digital certificate 174A is then returned to CO-1 120C. An entity (e.g., ES 140A) that receives SYH digital certificate 174A can verify the validity of the root key signature by using CO-1 public key 404, which is published and available to the verifying entity. In operation, the CA CO-0 system 402 can create a SYH digital certificate for each of the other COs 120A (i.e., CO-2 120D and CO-3 120E) using their sets of public keys. The appropriate CO's SYH digital certificate (e.g., SYH digital certificate 174A) can be incorporated in any signed command submitted to the ES 140A by the actors 302 (shown in FIG. 3), and the ES 140A will check the root key signature in order to validate that the entity submitting the SYH digital certificate is in possession of a valid SYH digital certificate. An adversary will not be able to forge a SYH digital certificate 174, 174A because the SYH digital certificates will be signed the CA CO-0 root key 420. Although the SYH digital certificate 174, 174A will, in principle, be public knowledge, an adversary cannot use the SYH digital certificate as its own because the public key in the SYH digital certificate 174, 174A matches the public key of the authorized entity for which the SYH certificate 174, 174A was generated, and because the public key is known independently by the authorizing entity when it is time to validate the SYH certificate 174, 174A.

An example operation of the system 100A will now be provided with respect to the following operations identified as Operations A-N. In Operation A, the CO-0 120B signs CO-1's public keys generating, in effect, a certificate (e.g., SYH digital certificate 174) and returns the SYH certificate to the CO-1 120B. In Operation B, a set of public keys for the CO-0 120B and an initial set of public keys (ECC) for the CO-1 120C are loaded onto the ES 1440A in a secure facility. In Operation C, the CO-1 120C authorizes updates to CO1-relevant states (code, keys, etc.) of the ES 140A by signing an appropriate command with the current set of CO-1 private keys and including in the command the certificate received from the CO-0 120B. In Operation D, the CO-1 120C (e.g., through the operator 160A) releases the signed command to the general public.

Time is allowed to pass, and in Operation E, an actor 302 (e.g., a customer of the overall owner of the ES 140A) decides to update the CO-1-relevant state of ES 140A and presents the signed command to the ES 140A. In Operation F, the ES 140A verifies the identity of the issuer of the signed command (i.e., verifies that the CO-1 120C issued the command) by verifying the signature on the command using the set of CO-1 public keys stored on the ES 140A; by verifying the signature of the CO-0 120B on the CO-1 key certificate using the set of CO-0 public keys stored on the ES 140A; and by ensuring that the values of the CO-1 public keys in the CO-1 key certificate match the values of the CO-1 public keys on the ES 140A. It is noted that one effect of the command can be to update the set of public keys for the CO-1 120C. In Operation G, an initial set of keys for the CO-2 120D is generated in a secure manner, and the CO-2 120D sends the public halves of the initial set of keys to the CO-1 120C and to the CO-0 120B. In Operation H, the CO-1 120C signs the public keys of CO-2 120D generating, in effect, a certificate and returns the certificate to CO-2 120D. In Operation I, the CO-0 120B does the same thing with the public keys of CO-2 120D that it did with the public keys of CO-1 120C in Operation A. The CO-0 120B signs the public keys of CO-2 120D and returns the resulting SYH certificate to CO-2 120D. In Operation J, the CO-2 120D authorizes updates to CO-2-relevant state of the ES 140A by signing an appropriate command with the current set of private keys of the CO-2 120D and including in the command the certificate received from the CO-0 120C. The first such command presented to the ES 140A must incorporate the CO-1-signed certificate and has the effect of loading the public keys of the CO-2 120D onto the ES 140A. In Operation K, the CO-2 120D releases the signed command to the general public.

Time is allowed to pass, and in Operation L, Operation E is repeated except in Operation L the operator 160A is updating the CO2-relevant state of the ES 140A. In Operation M, Operation F is repeated, and the ES 140A verifies that the CO-2 120D issued the command by verifying the signature on the command using the set of public keys of the CO-2 120D contained in the command. In Operation N, the ES 140A verifies that the public keys of the CO-2 120D in the command are valid by verifying the signature on the CO-1-signed certificate using the set of public keys of the CO-1 120C stored on the ES 140A; by verifying the CO-0 signature on the CO-2 key certificate using the set of public keys of the CO-0 120B stored on the ES 140A; and by ensuring that the public keys in the CO-2 certificate matches the public keys of the CO-2 in the command.

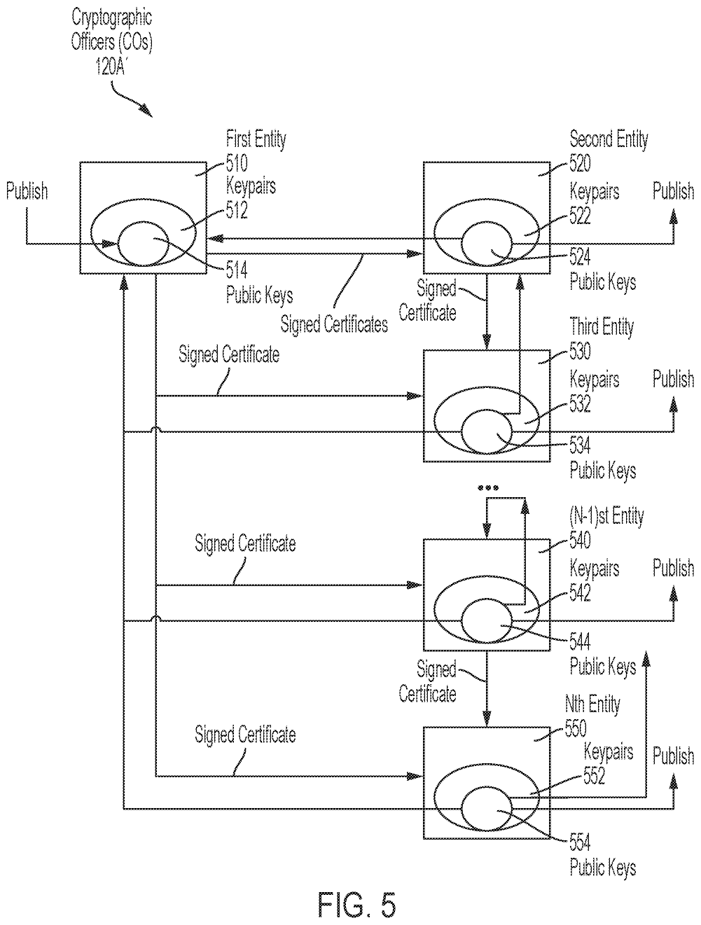

Referring now to FIG. 5,example operations of a portion of the system 100A (shown in FIG. 3) will now be provided with respect to a set of COs 120A′, which correspond to the COs 120A (shown in FIG. 3). The COs 120A′ include a first entity 510 that corresponds to the CO-0 120B (shown in FIG. 3), along with a second entity 520, a third entity 530, an N-1 entity 540, and an Nth entity 550, configured and arranged as shown. Entities 520, 530, 540 correspond to CO-1 120C, CO-2 120D, and CO-3 120E, respectively. Entity 550 is an Nth entity that represents a CO-N, where N is any number equal to 4 or greater. The following operations, which are identified as Operations AA-SS, demonstrate examples of how the entities 510-550 (i.e., the COs 120A) interact with one another in the course of implementing certificate-based MFA in accordance with aspects of the invention.

The following operations illustrate an example of how certificate-based MFA can be implemented using an ES (e.g., ES 140A). In Operation AA, the first entity 510 generates a set of first entity private/public keypairs 512 (e.g., root keypairs) and extracts therefrom first entity public keys 514. In Operation BB, the second entity 520 generates a set of second entity private/public keypairs 522, extracts therefrom second entity public key 524, and sends the second entity public key 524 to the first entity 510. In Operation CC, the first entity 510 signs the second entity public key 524 to generate second entity digital certificates that contain the second entity public keys 524 and the first entity certificate signatures. In Operation DD, the first entity 510 returns the second entity certificates and the first entity public keys to the second entity 520. In Operation EE, at a secure facility, the first entity public keys 514, and the second entity public key 524 are loaded onto an ES.

The following operations illustrate an example of how authorization to provide updates to owned resources are provided. In Operation FF, an entity (e.g., the second entity 520) that owns a subset of the ES's resources (e.g., code, stored entity keys) authorizes updates to those resources by incorporating in a signed command the new state of the resources; the certificates the entity that owns the resources obtained from the first entity 510; and signatures created using the private keys for the entity that owns the resources that cover the signed command. In Operation GG, the entity that owns the resources publicly releases the signed command.

The following operations illustrate an example of how validation of the certificate-based MFA for owned resources can be provided. In Operation HH, an operator (e.g., Operator 160A) presents the signed command publicly released by an entity (e.g., the second entity 520) to the ES. In Operation JJ, the ES verifies the identity of the issuer of the signed command (e.g., the second entity 520) by verifying the command signatures generated by the issuer using the issuer's public keys stored on the ES; verifying the signatures on the first entity certificates contained in the command using the first entity public keys 514 stored on the ES; and ensuring the public keys in the certificates match the issuer's public keys stored on the ES.

The following operations illustrate an example of how authorization to provide updates to owned resources can be extended to additional entities. In Operation II, an entity not yet named (e.g., a third entity 530) that wishes to obtain ownership of a subset of the ES's resources and subsequently update them generates a set of private/public key pairs. In Operation JJ, the entity that generated the keypairs sends the entity's public keys to the first entity 510 and to the entity (e.g., the second entity 520) that owns the resources of the ES, a subset of which the entity that generated the keypairs wishes to control. In Operation KK, the first entity 510 signs the public keys of the entity that generated the keypairs to generate certificates, which contain the public keys and the first entity certificate signatures. In Operation LL, the first entity 510 returns the certificates to the entity that generated the keypairs. In Operation MM, the entity that owns the resources of the ES signs the public keys of the entity that generated the keypairs to generate a second set of certificates, which contain the public keys and the certificate signatures generated by the entity that owns the resources of the ES resources. In Operation NN, the entity that owns the resources of the ES returns the second set of certificates and the certificates generated by the first entity 510 for the entity that owns the resources of the ES 140A to the entity that generated the keypairs.

The following operations illustrate an example of how authorization to own resources can be further extended to additional entities. In Operation OO, an entity (e.g., the third entity 530) that wishes to obtain ownership of a subset of the ES's resources and to make updates to the ES state pertaining to those resources (e.g., code, stored entity keys) being authorized by incorporating in a signed command the requisite updates, (including the entity's public key(s)); the certificates returned to the entity by the first entity 510 and the certificates returned to the entity by the entity that owns the resources (as described in Operations II-NN); and signatures created using the private keys for the entity that wishes to obtain ownership that cover the signed command. In Operation PP, the entity that wishes to obtain ownership publicly releases the signed command.

The following operations illustrate an additional example of how validation of the certificate-based MFA for ownership of resources can be further extended to additional entities. In Operation QQ, an operator (e.g., operator 160A) presents the signed command publicly released by its issuer (e.g., the third entity 530) to the ES. In Operation RR, the ES verifies that the public keys of the issuer of the signed command (e.g., the third entity 530) are valid by verifying the signatures on the certificates for the issuer's public keys generated by the first entity 510 using the public keys 514 of the first entity 510 stored on the ES; ensuring the public keys in the issuer's certificates generated by the first entity 510 match the public keys of the issuer contained in the command; verifying the signatures on the certificates for the public keys of the entity (e.g., the second entity 520) that owns the resources generated by the first entity 510 using the public keys 514 of the first entity 510 stored on the ES; ensuring the public keys in the certificates of the entity that owns the resources generated by the first entity 510 match the public keys of the entity that owns the resources stored on the ES; and verifying the signatures on the certificates for the issuer's public keys generated by the entity that owns the resources using the public keys of the entity that owns the resources stored on the ES. In Operation SS, the ES verifies the identity of the issuer of the command (e.g., the third entity 530) by verifying the signatures on the command using the public keys of the issuer contained in the command.

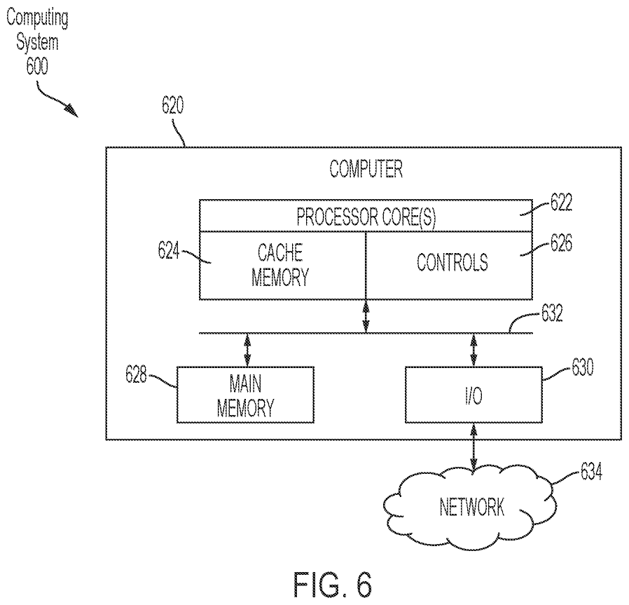

FIG. 6 illustrates an example of a computer system 600 that can be used to implement any of the computer-based components of the various embodiments of the invention described herein. The computer system 600 includes an exemplary computing device (“computer”) 602 configured for performing various aspects of the content-based semantic monitoring operations described herein in accordance aspects of the invention. In addition to computer 602, exemplary computer system 600 includes network 614, which connects computer 602 to additional systems (not depicted) and can include one or more wide area networks (WANs) and/or local area networks (LANs) such as the Internet, intranet(s), and/or wireless communication network(s). Computer 602 and additional system are in communication via network 614, e.g., to communicate data between them.

Exemplary computer 602 includes processor cores 604, main memory (“memory”) 610, and input/output component(s) 612, which are in communication via bus 603. Processor cores 604 includes cache memory (“cache”) 606 and controls 608, which include branch prediction structures and associated search, hit, detect and update logic, which will be described in more detail below. Cache 606 can include multiple cache levels (not depicted) that are on or off-chip from processor 604. Memory 610 can include various data stored therein, e.g., instructions, software, routines, etc., which, e.g., can be transferred to/from cache 606 by controls 608 for execution by processor 604. Input/output component(s) 612 can include one or more components that facilitate local and/or remote input/output operations to/from computer 602, such as a display, keyboard, modem, network adapter, etc. (not depicted).

As previously noted herein, conventional techniques related to making and using aspects of the invention are well-known so may or may not be described in detail herein. However, to provide context, a more detailed description of various cryptography methods and definitions that can be utilized in implementing one or more embodiments of the present invention will now be provided.

Digital certificates support public key cryptography in which each party involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are supposed to be known only to a particular entity, i.e. kept secret. In a typical public key cryptographic system, a private key corresponds to exactly one public key.

Within a public key cryptography system, because all communications involve only public keys and no private key is ever transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption. Accordingly, public key cryptography is an asymmetric scheme that uses a pair of keys—specifically, a public key that is used to encrypt data, along with a corresponding private or secret key that is used to decrypt the data. The public key can be published to the world while the private key is kept secret. Any entity having a copy of the public key can then encrypt information that the entity in possession of the secret/private key can decrypt and read.

Encryption is the transformation of data into a form unreadable by anyone without a secret decryption key; encryption ensures privacy by keeping the content of the information hidden from anyone for whom it is not intended, even those who can see the encrypted data. Authentication is a process whereby the receiver of a digital message can be confident of the identity of the sender and/or the integrity of the message. For example, when a sender encrypts a message, the public key of the receiver is used to transform the data within the original message into the contents of the encrypted message. A sender uses a public key to encrypt data, and the receiver uses a private key to decrypt the encrypted message.

A certificate is a digital document that vouches for the identity and key ownership of entities, such as an individual, a computer system, a specific server running on that system, etc. Certificates are issued by certificate authorities. A certificate authority (CA) is an entity, usually a trusted third party to a transaction that is trusted to sign or issue certificates for other people or entities. The CA usually has some kind of legal responsibilities for its vouching of the binding between a public key and its owner that allow one to trust the entity that signed a certificate. There are many such certificate authorities, and they are responsible for verifying the identity and key ownership of an entity when issuing the certificate.

In keeping with the known ways in which SYK digital certificates are used, if a certificate authority issues a certificate for an entity, the entity provides a public key and some information about the entity. A software tool, such as specially equipped web browsers, can digitally sign this information and send it to the certificate authority. The certificate authority might be a company or other entity that provides trusted third-party certificate authority services. The certificate authority will then generate the certificate and return it. The certificate can contain other information, such as dates during which the certificate is valid and a serial number. One part of the value provided by a certificate authority is to serve as a neutral and trusted introduction service, based in part on their verification requirements, which are openly published in their certification service practices (CSP).

Typically, after the CA has received a request for a new digital certificate, which contains the requesting entity's public key, the CA signs the requesting entity's public key with the CA's private key and places the signed public key within the digital certificate. Anyone who receives the digital certificate during a transaction or communication can then use the public key of the CA to verify the signed public key within the certificate. The intention is that an entity's certificate verifies that the entity owns a particular public key. There are several standards that define the information within a certificate and describe the data format of that information.

The terms “cryptography,” “cryptosystems,” “encryption,” and equivalents thereof are used herein to describe secure information and communication techniques derived from mathematical concepts, including, for example, rule-based calculations called algorithms configured to transform messages in ways that are hard to decipher without authorization. Cryptography uses a set of procedures known as cryptographic algorithms, encryption algorithms, or ciphers, to encrypt and decrypt messages in order to secure communications among computer systems and applications. A cryptography suite can use a first algorithm for encryption, a second algorithm for message authentication, and a third algorithm for key exchange. Cryptographic algorithms, which can be embedded in protocols and written in software that runs on operating systems and networked computer systems, involve public and private key generation for data encryption/decryption; digital signing and verification for message authentication; and key exchange operations.

The terms “asymmetric-key encryption algorithm” and equivalents thereof are used herein to describe public-key or asymmetric-key algorithms that use a pair of keys, a public key associated with the creator/sender for encrypting messages and a private key that only the originator knows for decrypting that information.

The term “key” and equivalents thereof are used herein to describe a random string of bits created explicitly for scrambling and unscrambling data. Keys are designed with algorithms intended to ensure that every key is unpredictable and unique. The longer the key built in this manner, the harder it is to crack the encryption code. A key can be used to encrypt, decrypt, or carry out both functions based on the sort of encryption software used.

The terms “private key” and equivalents thereof are used herein to describe a key that is paired with a public key to set off algorithms for text encryption and decryption. A private key is created as part of public key cryptography during asymmetric-key encryption and used to decrypt and transform a message to a readable format. Public and private keys are paired for secure communication. A private key is shared only with the key's initiator, ensuring security. For example, A and B represent a message sender and message recipient, respectively. Each has its own pair of public and private keys. A, the message initiator or sender, sends a message to B. A's message is encrypted with B's public key, while B uses its private key to decrypt A's received message. A digital signature, or digital certificate, is used to ensure that A is the original message sender. To verify this, B uses the following steps: B uses A's public key to decrypt the digital signature, as A must previously use its private key to encrypt the digital signature or certificate; and, if readable, the digital signature is authenticated with a certification authority (CA). Thus, sending encrypted messages requires that the sender use the recipient's public key and its own private key for encryption of the digital certificate. Thus, the recipient uses its own private key for message decryption, whereas the sender's public key is used for digital certificate decryption.

The terms “public key” and equivalents thereof are used herein to describe a type of encryption key that is created in public key encryption cryptography that uses asymmetric-key encryption algorithms. Public keys are used to convert a message into an unreadable format. Decryption is carried out using a different, but matching, private key. Public and private keys are paired to enable secure communication.

The terms “digital signature” and equivalents thereof are used herein to describe techniques that incorporate public-key cryptography methodologies to allow consumers of digitally signed data to validate that the data has not been changed, deleted or added. In an example digital signature technique/configuration, a “signer” hashes the record data and encrypts the hash with the signer's private key. The encrypted hash is the signature. The consumer of the record data can hash the same record data, and then use the public key to decrypt the signature and obtain the signer's hash. A consumer attempting to validate a record can compare the consumer's hash with the signer's hash. When the two hash values match, the data content and source(s) of the record are verified.

The terms “elliptic curve cryptography” (ECC) describes algorithms that use the mathematical properties of elliptic curves to produce public key cryptographic systems. Like all public-key cryptography, ECC is based on mathematical functions that are simple to compute in one direction but very difficult to reverse. In the case of ECC, this difficulty resides in the infeasibility of computing the discrete logarithm of a random elliptic curve element with respect to a publicly known base point, or the “elliptic curve discrete logarithm problem” (ECDLP). The elliptic curve digital signature algorithm (ECDSA) is a widely-used signing algorithm for public key cryptography that uses EC.

The terms “resources,” “system resources,” “embedded system resources,” “coprocessor resources,” and equivalents thereof are used herein to describe the various types of resources available within computing systems, including the CPU, video card, hard drive, and memory. System resources can also refer to categories of software installed on the computing system, including, for example, application programs, operating systems, utilities, fonts, updates, and other software that is installed on the computing system's hard drive.

The terminology used herein is for the purpose of describing particular embodiments only and is not intended to be limiting of the invention. As used herein, unless the context clearly indicates otherwise, the singular forms “a”, “an” and “the” are intended to include the plural forms. The terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The term “exemplary” is used herein to mean “serving as an example, instance, or illustration.” Any embodiment or design described herein as “exemplary” is not necessarily to be construed as preferred or advantageous over other embodiments or designs. The terms “at least one” and “one or more” can include any integer number greater than or equal to one, i.e. one, two, three, four, etc. The terms “a plurality” can include any integer number greater than or equal to two, i.e. two, three, four, five, etc. The term “connection” can include both an indirect “connection” and a direct “connection.”

The terms “about,” “substantially” and equivalents thereof are intended to include the degree of error associated with measurement of the particular quantity based upon the equipment available at the time of filing the application. For example, “about,” “substantially” and equivalents thereof can include a range of ±8% or 5%, or 2% of a given value.

The flowchart and block diagrams depicted herein are example embodiments of the invention described herein. Variations can be made to the flowcharts, steps/operations, and block diagrams described and illustrated herein without departing from the spirit of the invention. For instance, the illustrated flowchart operations can be performed in a differing order or operations can be added, deleted or modified. For example, two blocks shown in succession can, in fact, be executed substantially concurrently, or the blocks can sometimes be executed in the reverse order, depending upon the functionality involved. Each block of the block diagrams and/or flowchart illustration, as well as the combinations of blocks in the block diagrams and/or flowchart illustration, can be implemented by special purpose hardware-based systems that perform the specified functions or acts, or combinations of special purpose hardware and computer instructions. All of these variations are considered a part of the claimed invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been described in detail in connection with only a limited number of embodiments, it should be readily understood that the present invention is not limited to such disclosed embodiments. Rather, the present invention can be modified to incorporate any number of variations, alterations, substitutions or equivalent arrangements not heretofore described, but which are commensurate with the spirit and scope of the present invention. Additionally, while various embodiments of the present invention have been described, it is to be understood that aspects of the present invention can include only some of the described embodiments. Accordingly, the present invention is not to be seen as limited by the foregoing description, but is only limited by the scope of the appended claims.

What is claimed is:

1. A computer-implemented method of executing multi-factor authentication (MFA), the computer-implemented method comprising:
analyzing multiple categories of MFA factors;
wherein a first category of the multiple categories of MFA factors comprises a something-you-have MFA (SYH-MFA) factor;
wherein analyzing the SYH-MFA factor comprises:
receiving, using a processor of an authenticating entity, an SYH certificate from a to-be-authenticated (TBA) entity; and
determining, using the processor, that the SYH-MFA factor is satisfied by determining that the SYH certificate possessed by the TBA entity is valid.

2. The computer-implemented method of claim 1, wherein:
the SYH certificate includes key data; and
determining that SYH certificate possessed by the TBA entity is valid comprises determining that the key data of the SYH certificate comprises valid key data.

3. The computer-implemented method of claim 1, wherein:
a second category of the multiple categories of MFA factors comprises a something-you-know MFA (SYK-MFA) factor; and
analyzing the SYK-MFA factor comprises:
receiving, using the processor, an SYK-MFA certificate from the TBA entity, wherein the SYK-MFA certificate includes an SYK-MFA digital signature created by the TBA entity; and
determining, using the processor, that the SYK-MFA factor is satisfied by determining that the SYK-MFA digital signature created by the TBA entity comprises a valid SYK digital signature.

4. The computer-implemented method of claim 1, wherein the authenticating entity is selected from the group consisting of an embedded system, a coprocessor, and a hardware security module.

5. The computer-implemented method of claim 4, wherein:
the key data of the SYH certificate comprises a public key; and
the SYH certificate is generated using a certificate-authority cryptographic-officer (CA-CO) system configured to verify credentials of an authorized entity.

6. The computer-implemented method of claim 5, wherein the authorized entity is authorized to make changes to resources of the authenticating entity.

7. The computer-implemented method of claim 6, wherein the authenticating entity determines that the public key of the SYH certificate is the public key of the authorized entity by:
comparing the public key of the SYH certificate to the public key of the authorizing entity; and
determining that the public key of the SYH certificate has been digitally signed by the CA-CO system using a root key that is known to the authenticating entity and associated with a CA-CO.

8. A computer system comprising a memory communicatively coupled to a processor, wherein the processor is configured to perform processor operations for executing multi-factor authentication (MFA), the processor operations comprising:
analyzing multiple categories of MFA factors;
wherein a first category of the multiple categories of MFA factors comprises a something-you-have MFA (SYH-MFA) factor;
wherein analyzing the SYH-MFA factor comprises:
receiving an SYH certificate from a to-be-authenticated (TBA) entity; and
determining that the SYH-MFA factor is satisfied by determining that the SYH-MFA certificate possessed by the TBA entity is valid.

9. The computer system of claim 8, wherein:
the SYH certificate includes key data; and
determining that SYH certificate possessed by the TBA entity is valid comprises determining that the key data of the SYH certificate comprises valid key data.

10. The computer system of claim 8, wherein:
a second category of the multiple categories of MFA factors comprises a something-you-know MFA (SYK-MFA) factor; and
analyzing the SYK-MFA factor comprises:
receiving an SYK-MFA certificate from the TBA entity, wherein the SYK-MFA certificate includes a digital signature created by the TBA entity; and
determining that the SYK-MFA factor is satisfied by determining that the SYK-MFA digital signature created by the TBA entity comprises a valid SYK digital signature.

11. The computer system of claim 9, wherein:
the processor is incorporated within an authenticating entity; and
the authenticating entity is selected from the group consisting of an embedded system, a coprocessor, and a hardware security module.

12. The computer system of claim 11, wherein:
the key data of the SYH certificate comprises a public key; and
the SYH certificate is generated using a certificate-authority cryptographic-officer (CA-CO) system configured to verify credentials of an authorized entity.

13. The computer system of claim 12, wherein the authorized entity is authorized to make changes to resources of the authenticating entity.

14. The computer system of claim 13, wherein the authenticating entity determines that the public key of the SYH certificate is the public key of the authorized entity by:
comparing the public key of the SYH certificate to the public key of the authorizing entity; and
determining that the public key of the SYH certificate has been digitally signed by the CA-CO system using a root key that is known to the authenticating entity and associated with a CA-CO.

15. A computer program product for executing multi-factor authentication (MFA), the computer program product comprising a computer readable program stored on a computer readable storage medium, wherein the computer readable program, when executed on the processor, causes the processor to perform a method comprising:
analyzing multiple categories of MFA factors;
wherein a first category of the multiple categories of MFA factors comprises a something-you-have MFA (SYH-MFA) factor;
wherein analyzing the SYH-MFA factor comprises:
receiving an SYH certificate from a to-be-authenticated (TBA) entity; and
determining that the SYH-MFA factor is satisfied by determining that the SYH-MFA certificate possessed by the TBA entity is valid.

16. The computer program product of claim 15, wherein:
the SYH certificate includes key data; and
determining that SYH certificate possessed by the TBA entity is valid comprises determining that the key data of the SYH certificate comprises valid key data.

17. The computer program product of claim 15, wherein:
a second category of the multiple categories of MFA factors comprises a something-you-know MFA (SYK-MFA) factor; and
analyzing the SYK-MFA factor comprises:
receiving an SYK-MFA certificate from the TBA entity, wherein the SYK-MFA certificate includes a digital signature created by the TBA entity; and
determining that the SYK-MFA factor is satisfied by determining that the SYK-MFA digital signature created by the TBA entity comprises a valid SYK digital signature.

18. The computer program product of claim 16, wherein:
the processor is incorporated within an authenticating entity; and
the authenticating entity is selected from the group consisting of an embedded system, a coprocessor, and a hardware security module.

19. The computer program product of claim 18, wherein:
the key data of the SYH certificate comprises a public key; and
the SYH certificate is generated using a certificate-authority cryptographic-officer (CA-CO) system configured to verify credentials of an authorized entity.

20. The computer program product of claim 19, wherein:
the authorized entity is authorized to make changes to resources of the authenticating entity; and
the authenticating entity determines that the public key of the SYH certificate is the public key of the authorized entity by:
comparing the public key of the SYH certificate to the public key of the authorizing entity; and
determining that the public key of the SYH certificate has been digitally signed by the CA-CO system using a root key that is known to the authenticating entity and associated with a CA-CO.
